(19) United States
(12) Patent Application Publication
(10) Pub. No.: US 2007/0040926 A1
(43) Pub. Date: Feb. 22, 2007

(54) Replaceable imaging device unit, camera body and camera system

(75) Inventor: Masafumi Inuiya, Kanagawa (JP)

Correspondence Address: SUGHRUE-265550, 2100 PENNSYLVANIA AVE. NW, WASHINGTON, DC, 20037-3213, US

(73) Assignee: FUJI PHOTO FILM CO., LTD.

(21) Appl. No.: 11/503,955

(22) Filed: Aug. 15, 2006

(30) Foreign Application Priority Data
Aug. 16, 2005 (JP) P2005-235958

(51) Int. Cl. H04N 5/225

(52) U.S. Cl. 348/340

(57) ABSTRACT

An imaging device unit to be removably attached to a camera body having an objective lens, the imaging device unit comprising: a board; a solid-state imaging device fixed on the board; and an abutment region formed on the board, and to abut against a reference plate provided on the camera body in a state the imaging device unit is attached to the camera body, wherein, in a state the abutment region is abutted against the reference plate, the solid-state imaging device has an imaging surface in a position coincident with a focal point of the objective lens.

### BACKGROUND OF THE INVENTION

1. Field of the Invention

The present invention relates to a camera system having a camera body having an optical lens system, a solid-state imaging device wherein an imaging device unit is to be removaly attached to the camera body, and more particularly to the alignment of between the camera body and the imaging device unit.

2. Description of the Related Art

In the related art, there are widespread camera systems, including digital and monitor cameras, which are mounted with solid-state imaging devices including CCD and CMOS sensors. Meanwhile, in order to permit the replacement of the solid-state imaging device for the camera system in accordance with photography purpose and solid-state imaging device performance improvement, there is proposed a camera system having a camera body having an optical lens system and an imaging device unit, having a solid-state imaging device, to be removably attached to the camera body.

However, in the digital camera incorporating a solid-state imaging device, there is a possibility to cause shading unless designing the objective lens and the solid-state imaging device in a manner to match the travel distance of the objective lens and the displacement of the microlens for the solid-state imaging device with each other. Meanwhile, in order to prevent color noise, there is a need to design the optical low-pass filter to a characteristic matched to the pitch of solid-state imaging device elements. Thus, the solid-state imaging device undergoes positional restriction relative to the objective lens.

For the camera system removably attached to an imaging device unit, there is a problem in aligning the imaging device unit with the camera body such that the objective lens of the camera body has a focal point coincident with the imaging surface of the solid-state imaging device of the imaging device unit.

### SUMMARY OF THE INVENTION

The present invention has been made in view of the above circumstances, and it is an object thereof to provide a camera system that the imaging device unit is to be removably attached to the camera body wherein the imaging device unit is to be properly aligned with the camera body.

The foregoing object is to be achieved by an imaging device unit to be removably attached to a camera body having an objective lens, the imaging device unit comprising: a board; a solid-state imaging device fixed on the board; and an abutment region formed on the board, and to abut against a reference plate provided on the camera body in a state the imaging device unit is attached to the camera body, wherein, in a state the abutment region is abutted against the reference plate, the solid-state imaging device has an imaging surface in a position coincident with a focal point of the objective lens.

In the imaging device unit according to the invention, when the imaging device unit is attached to the camera body, the abutment region formed on the imaging device unit abuts against the reference plate of the camera body, thereby holding the imaging device unit in a state its imaging surface is coincident with a focal point of the objective lens. Due to this, during taking an image, the imaging surface of the imaging device unit can be properly, relatively aligned with the focal point of the objective lens at all times. Therefore, the imaging device unit in the invention can prevent the occurrence of shading or color noise similarly to the related-art camera system solid-state imaging device arranged to be previously attached to its camera body based on a predetermined design.

Meanwhile, by using the imaging device unit according to the invention, the imaging device unit can be changed for a desired objective lens in accordance with use purpose without selecting an objective lens matched to the characteristic of the solid-state imaging device.

It is preferable that, in the imaging device unit, the abutment region comprises: a first abutment region to abut against a first reference plane of the reference plate formed vertical to an optical axis of the objective lens; a second abutment region to abut against a second reference plane formed vertical to the imaging surface; and a third abutment region to abut against a third reference plane formed vertical to the imaging surface and to the second reference plane. Here, it is assumed that the axis vertical to the first reference plane is defined as z-axis, the axis vertical to the second reference plane is as x-axis and the axis vertical to the third reference plane is as y-axis. Then, by abutting the first, second and third abutment regions respectively at the first, second and third reference planes, the imaging device unit can be aligned in three-dimensional directions as defined x, y and z axes, respectively.

It is preferable that, in the imaging device unit, the abutment region comprises a projection formed on the board. By doing so, when the imaging device unit is attached to the camera body, the projection of the board is placed in abutment against the reference plane on the camera body. This can hold the imaging device unit in a state its imaging surface is coincident with a focal point of the objective lens. In this case, by forming the projection in a predetermined size, it is possible to previously perform an alignment in a manner to place the projection and the on-camera-body reference plate in a proper abutment position.

Meanwhile, the foregoing object of the invention is to be achieved by a camera body to removably attach to an imaging device unit having a solid-state imaging device, the camera body comprising: a body case; an objective lens mounted on the body case; and a receptacle formed in the body case and to attach to the imaging device unit, wherein the receptacle comprises a reference plate that regulates a position of the imaging device unit such that the solid-state imaging device has an imaging surface in a position coincident with a focal point in a state the imaging device unit is attached to the receptacle.

In the camera body according to the invention, when the imaging device unit is attached to the camera body, the reference plate provided on the camera body regulates the position of the abutment region of the imaging device unit, thereby holding the imaging device unit in a state its imaging surface is coincident with a focal point of the objective lens. Due to this, during taking an image, it is properly perform an alignment relatively between the focal point of the objective lens and the imaging surface of the imaging device unit at all times. Therefore, the camera body in the invention can prevent the occurrence of shading or color noise similarly to the related-art camera system solid-state imaging device arranged to be previously attached to its camera body based on a predetermined design.

It is preferable that, in the camera body, in a state the imaging device unit is attached to the receptacle, the reference plate comprises: a first reference plane vertical to the optical axis of the objective lens; a second reference plane formed vertical to the imaging surface; and a third reference plane formed vertical to the imaging surface and to the second reference plane, and the imaging surface is regulated in position by the first, second and third reference planes. Here, it is assumed that the axis vertical to the first reference plane is defined as z-axis, the axis vertical to the second reference plane is as x-axis and the axis vertical to the third reference plane is as y-axis. Then, by abutting the first, second and third abutment regions respectively at the first, second and third reference planes, the imaging device unit can be aligned in three-dimensional directions as defined x, y and z axes, respectively.

It is preferable that, in the camera body, there is included an urge mechanism that pushes the imaging device unit onto the reference plate in a state the imaging device unit is attached to the receptacle. By doing so, when the imaging device unit is abutted against the reference plate by an urge mechanism, the abutment region of the imaging device unit abuts against the reference plate. The imaging device unit, while being attached to the camera body, is kept in the state the abutment region abuts against the reference plate. In this manner, the imaging device unit can be held such that its imaging surface is in a proper relative position to the focal point of the objective lens.

It is preferable that, in the camera body, the urge mechanism is a biasing member that urges the imaging device unit onto at least one of the first, second and third reference planes. In the state the imaging device unit is urged by the biasing member, the abutment region of the imaging device unit is urged on at least one of the reference planes. While the camera body is being attached to the camera body, the abutment region is kept in a state abutting against the reference plate by the urging force of the biasing member.

It is preferable that, in the camera body, there is included a window exposing the imaging device unit so that the imaging device unit can be visually recognized from an exterior of the camera body in a state the imaging device unit is attached to the camera body. This allows the user to visually recognize the presence or absence of the imaging device unit through the window, thus eliminating the labor and time for opening the camera body.

Furthermore, the foregoing object of the invention is to be achieved by the camera system and the camera body. When the imaging device unit is attached to the camera body, the abutment region formed on the imaging device unit abuts against the reference plate provided on the camera body, thus placing the imaging device unit in a state its imaging surface is coincident with a focal point of the objective lens. Due to this, during taking an image, it is possible to properly perform an alignment relatively between the focal point of the objective lens and the imaging surface of the imaging device unit at all times. Therefore, the imaging-unit in the invention can prevent the occurrence of shading or color noise similarly to the related-art camera system having a solid-state imaging device previously attached to a predetermined size in the camera body.

### BRIEF DESCRIPTION OF THE DRAWINGS

FIG. 1 is an overall perspective view showing a camera system according to the present invention;

FIG. 2 is a horizontal sectional view typically showing the state an imaging device unit is attached to a camera body;

FIG. 3 is a figure showing the state of the imaging device unit attached to the camera body, as viewed from an objective-lens side; and

FIG. 4 is an overall perspective view of the camera system as viewing the body case from a back-plate side.

### DETAILED DESCRIPTION OF THE INVENTION

An embodiment of the present invention will now be explained in detail based on the drawings.

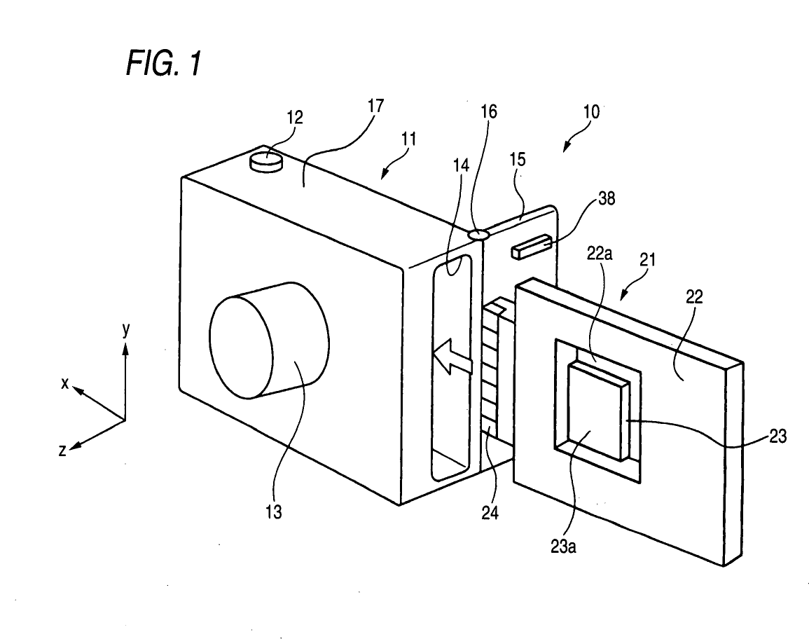

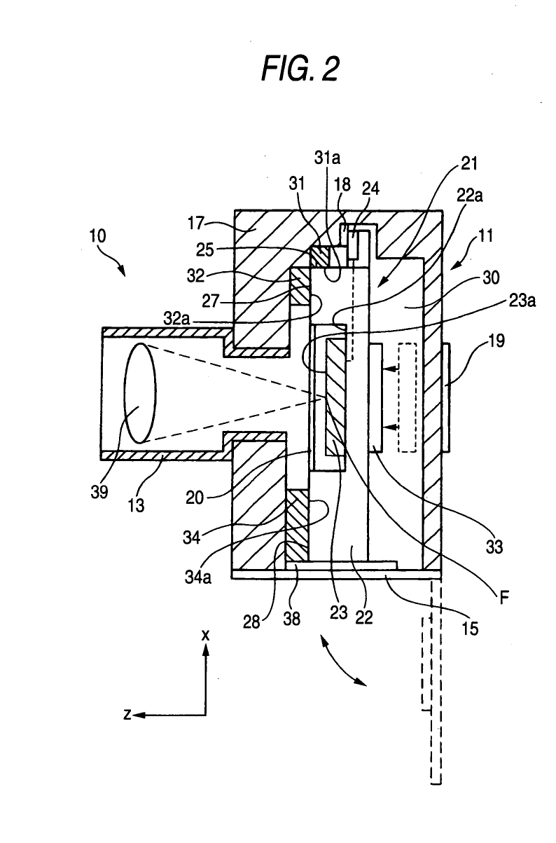

FIG. 1 is an overall perspective view illustrating a camera system according to the invention. FIG. 2 is a horizontal sectional view typically showing the state that an imaging device unit is attached to a camera body.

A camera system 10 includes a camera body 11 and an imaging device unit 21 to be removably attached to the camera body 11.

The camera body 11 has a body case 17 generally rectangular parallelepiped in form.

The body case 17 mounts thereon a lens barrel 13 that can be changed upon user's desire in accordance with a photographic subject. An objective lens 39 is fixed within the lens barrel 13. The objective lens 39 is to collect the luminous flux of image light from the subject and form a focus to which the luminous flux is collected to one point. Meanwhile, on the body case 17, there is provided an operating section 12, such as a shutter-release button, to be operated by the user's finger during taking a picture.

An insert-aperture 14 is formed in the body case 17 so that the imaging device unit 21 can be inserted in the body case 17 when attaching the imaging device unit 21. Meanwhile, a lid 15, for closing the insert-aperture 14, is arranged for opening and closing by means of a hinge 16. A biasing member 38 is provided on the inner surface of the lid 15 such that it abuts against part of an end surface of a board 22 in a closure state of the lid 15 and urges it in a direction the imaging device unit 21 is inserted (in FIG. 1 x-direction).

The imaging device unit 21 includes a board 22 formed as a plate member generally in a rectangular parallelepiped, a solid-state imaging device 23 fixed on the board 22, and a unit-end electrode terminal 24 electrically connected by a wiring line, not shown, to a drive circuit, not shown, for taking drive control of the solid-state imaging device 23.

The solid-state imaging device 23, in the invention, can use a CCD or a CMOS, for example. The solid-state imaging device 23 is fixed on a bottom of a recess 22a formed in one surface of the board 22 by means of an adhesive or the like such that its imaging surface 23a, for light reception, is exposed to the exterior of the imaging device unit 21. In the board 22, a transparent seal glass 20 is provided in a manner shielding the recess 22a, in order to prevent a foreign matter, such as a dust or dirt, from being put on the solid-state imaging device 23 fixed in the bottom of the recess 22a. Thus, the solid-state imaging device 23 is hermetically closed within the recess 22a.

As shown in FIG. 2, a receptacle 30 is provided in the camera body 11, to receive the imaging device unit 21 and hold it within the camera body 11. When attaching the imaging device unit 21 to the camera body 11, the imaging device unit 21 is inserted in the receptacle 30 in a state the solid-state imaging device 23, in the camera body 11, is positioned with its imaging surface 23a faced to the lens barrel 13. Meanwhile, in the state the imaging device unit 21 is attached to the camera body 11, electric connection is provided by contacting the unit-end electrode terminal 24 of the board 22 with a body-end electrode terminal 18 formed inside the camera body 11.

In the camera body 11, a display section 19, such as an LCD, is formed in a back plate of the body case 17, on the side opposite to the lens barrel 13.

The imaging device unit 21 is held in the receptacle 30 of the camera body 11 such that the solid-state imaging device 23 fixed on the board 21 is positioned vertically intersecting at its imaging surface 23a with the optical axis of the objective lens 39. In this case, the imaging device unit 21 is held in an aligned state such that the imaging surface 23a of the solid-state imaging device 23 comes a position coincident with the focal point F of the objective lens 39.

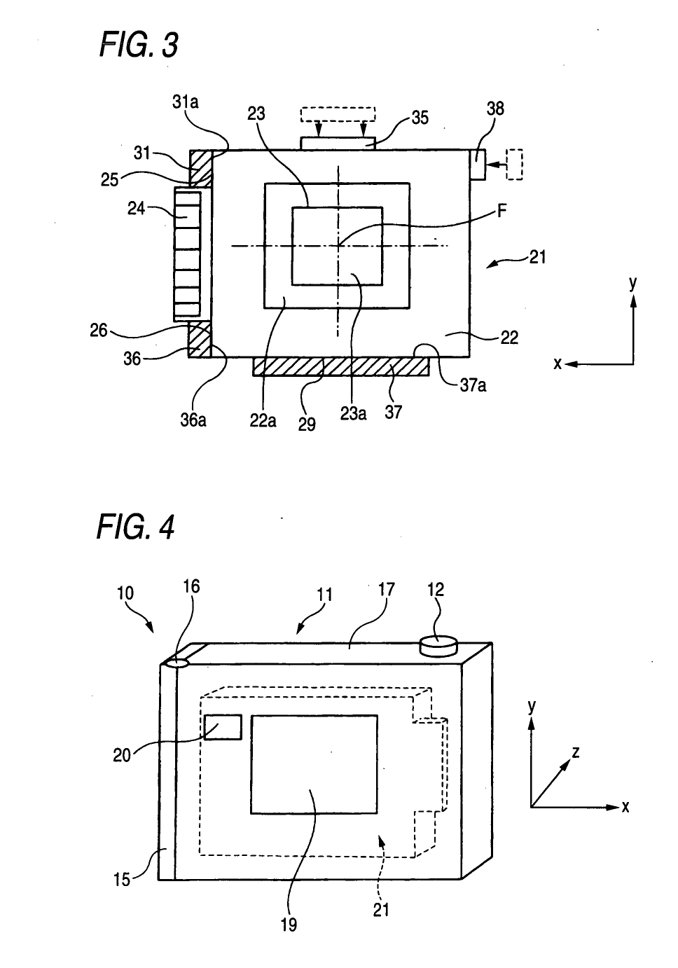

Explanation is now made on a structure that aligns the imaging device unit with the camera body 11. FIG. 3 shows a state that the imaging device unit 21 attached to the camera body 11 is viewed from the objective lens 39 side.

In the receptacle 30 of the camera body 11, reference plates 31, 32, 34, 36, 37 are provided to abut against the imaging device unit 21 attached and to align the imaging surface 23a of the solid-state imaging device 23 relatively with the objective lens 39.

In the state the imaging device unit 21 is attached, each of the reference plates 31, 32, 34, 36, 37 has a first reference plane perpendicular to the optical axis of the objective lens 39, a second reference plane formed vertical to the imaging surface 23a and a third reference plane formed vertical to the imaging surface 23a and to the second reference plane.

In this embodiment, the first reference plane refers to a surface 32a, 34a of the reference plate 32, 34 on the side closer to and in abutment against the board 22 of the imaging device unit 21 with respect to the direction the imaging surface 23a of the solid-state imaging device 23 opposes to the objective lens 39 (with respect to the arrow-z direction in FIG. 2).

The second reference plane refers to a surface 31a, 36a of the reference plate 31, 36 on the side closer to and in abutment against the board 22 of the imaging device unit 21 with respect to the direction the imaging device unit 21 is inserted into the receptacle 30 (with respect to the arrow-x direction in FIG. 3).

The third reference plane refers to a surface 37a of the reference plate 37 on the side closer to and in abutment against the board 22 of the imaging device unit 21 with respect to the direction vertical to the first and second reference planes (with respect to the arrow-y direction in FIG. 3).

Here, the board-side abutment surface 37a of the reference plate 37 may be taken as a second reference plane while the board-side abutment surface 31a, 36a of the reference plate 31, 36 may be taken as a third reference plane.

The imaging device unit 21 is provided with an abutment region at which abutted against the reference planes of the reference plates, in order to relatively align the imaging surface 23a with the objective lens 39.

The abutment region includes a first abutment region to abut against the first reference plane of the camera body 11, a second abutment region against the second reference plane and a third abutment region against the third reference plane.

In this embodiment, the first abutment region refers to an abutment region 27, 28 of the board 22 on the side abutting against the first reference plane 32a, 34a with respect to the direction the imaging surface 23a of the solid-state imaging device 23 opposes to the objective lens 39 (with respect to the arrow-z direction in FIG. 2).

The second abutment region refers to an abutment region 25, 26 of the board 22 on the side abutting against the second reference plane 31a, 36a with respect to the direction the imaging device unit 21 is inserted into the receptacle 30 (with respect to the arrow-x direction in FIG. 3).

Furthermore, the third abutment region refers to an abutment region 29 of the board 22 on the side abutting against the third reference plane 37a with respect to the direction vertical to the first and second abutment regions (with respect to the arrow-y direction in FIG. 3).

In this embodiment, the abutment region of the board 22 of the imaging unit 21 is made in a flat surface on the board 22, relative to the reference plates 31, 32, 34, 36, 37 of the camera body 11. However, the abutment region may be a projection formed on the board 22. In case the abutment region is made as a projection, when the imaging device unit 21 is attached to the camera body 11, the projection of the board 22 abuts against the reference plate 31, 32, 34, 36, 37. This makes it possible to hold the imaging device unit 21 in a state its imaging surface 23a is placed coincident with the focal point F of the objective lens 39. In this case, by forming the projection in a predetermined size, alignment is previously achieved such that the projection abuts against the reference plate 31, 32, 34, 36, 37 in a proper position. In this case, it is preferred that the focal point F positions at the center of the imaging surface 23a, as shown in FIG. 3.

Explanation is now made on a structure that holds the reference surfaces and the abutting regions in such a relative position as to provide an alignment of between the focal point of the objective lens 39 and the imaging surface 23a of the imaging device unit 11.

Biasing members 33, 35, 38 are provided interior of the body case 17. In the state the imaging unit 21 is attached to the receptacle 30 inside the body case 17, the biasing members 33, 35, 38 urge the imaging unit 21 toward the reference plates 31, 32, 34, 36, 37 of the camera body 21, thus constituting an urge mechanism acting to push the imaging unit 21. The urge mechanism and the imaging device unit 21 attached to the camera body 11 are kept in the state the abutment regions are placed in abutment against the reference plates 31, 32, 34, 36, 37 on the camera-body 11 side. In this manner, the imaging surface 23a of the imaging device unit 21 and the focal point of the camera body 11 are held in a proper position.

In this embodiment, the biasing member 33 is provided inside of the body case 17, to urge the first abutment region 27, 28 onto the first reference plane 32a, 34a.

The biasing member 38 is provided inside of the body case 17, to urge the second abutment region 25, 26 onto the second reference plane 31a, 36a.

The biasing member 35 is provided inside of the body case 17, to urge the third abutment region 29 onto the third reference plane 37a.

The biasing member 33, 35, 38 can use an elastic member such as a spring or of rubber. The biasing member 33, 35, 38 drives the imaging unit 21 forward and backward due to expansion and contraction thereof, for example. When the imaging device unit 21 is attached, the biasing members 33, 35, 38 are abutted against and compressed by the board 22 of the imaging device unit 21 thereby providing a structure to urge the imaging device unit 21 onto the reference plates 31, 32, 34, 36, 37 of the camera body 11 due to an elastic repelling force.

Meanwhile, in order to prevent the imaging device unit 21 and the biasing member 33, 35, 38 from interfering with each other when attaching the imaging device unit 21, the biasing members 33, 35, 38 may be structurally moved to a retracted position. Meanwhile, when attaching the imaging device unit 21, the biasing members 33, 35, 38 may be structurally moved respectively in the FIG. 3 arrow directions associatively with the movement of the imaging device unit 21, into an abutment against the imaging device unit 21.

The urge mechanism is preferably the biasing member 33, 35, 38 that urges the imaging unit 21 onto at least one of the first reference plane 32a, 34a, the second reference plane 31a, 36a and the third reference plane 37a. In the state the imaging device unit 21 is urged onto the biasing members 33, 35, 38, the imaging device unit 21 at its abutment region is urged onto at least one of the reference surfaces 31a, 32a, 34a, 36a, 37a. While the imaging device unit 21 is being attached to the camera body 11, the abutment region is placed in an abutment state against the reference plate 31, 32, 34, 36, 37 due to the urge force of the biasing members 33, 35, 38.

In the imaging device unit 21 according to the invention, when the imaging device unit 21 is attached to the camera body 11, the abutment region formed on the imaging device unit 21 abuts against the reference plate 31, 32, 34, 36, 37 of the camera body 11, thereby holding the imaging device unit 21 in the state its imaging surface 23a is aligned with the focal point F of the imaging device lens 39. This makes it possible to properly align relatively between the focal point F of the objective lens 39 and the imaging surface 23a of the imaging device unit 21, at all times. Therefore, the imaging device unit 21 in the invention can prevent against the occurrence of shading and color noise, similarly to the solid-state imaging device of the existing camera system structured for previous reception in the camera body based on a predetermined design.

Meanwhile, in case using the imaging device unit 21 according to the invention, the imaging device unit 21 can be changed for a desired objective lens in accordance with use purpose without selecting the objective lens 39 suited for the characteristic of the solid-state imaging device 23.

Meanwhile, concerning the camera body 11 according to the invention, when the imaging device unit 21 is attached to the camera body 11, the reference plates 31, 32, 34, 36, 37 provided in the camera body 11 regulate the position of the abutment regions of the imaging device unit 21. This makes it possible to hold the imaging surface 23a of the imaging device unit 21 in the aligned state with the focal point F of the objective lens 39. During taking an image, proper alignment is available at all times as to the relative position of the focal point F of the objective lens 39 and imaging surface 23a of the imaging device unit 21. Therefore, the camera body 11 in the invention can prevent against the occurrence of shading and color noise, similarly to the solid-state imaging device of the existing camera system structured for previous reception in the camera body due to a predetermined design.

FIG. 4 is an overall perspective view of the camera system as viewed the body case from the back-plate side. As shown in FIG. 4, a window 20 may be provided in the back plate of the body case 17. The window 20 may be provided by structuring part of the back plate of a transparent resin or the like. In the state the imaging device unit 21 is attached to the camera unit 11, the imaging device unit 21 attached to the receptacle 30 is partly exposed to the exterior of the body case 17 through the window 20. Due to this, the user is allowed to visually recognize the presence or absence of the imaging device unit 21 through the window 20. When confirming the imaging device unit 21, there is no need to open the lid 15 of the body case 17.

The present invention can provide a camera system having an imaging device unit to be removably attached to the camera body wherein the camera body and the imaging device unit are to be properly aligned.

The entire disclosure of each and every foreign patent application from which the benefit of foreign priority has been claimed in the present application is incorporated herein by reference, as if fully set forth.

What is claimed is:

1. An imaging device unit to be removably attached to a camera body having an objective lens, the imaging device unit comprising:
a board;
a solid-state imaging device fixed on the board; and
an abutment region formed on the board, and to abut against a reference plate provided on the camera body in a state the imaging device unit is attached to the camera body,
wherein, in a state the abutment region is abutted against the reference plate, the solid-state imaging device has an imaging surface in a position coincident with a focal point of the objective lens.

2. An imaging device unit according to claim 1, wherein the abutment region comprises:
a first abutment region to abut against a first reference plane of the reference plate formed vertical to an optical axis of the objective lens;
a second abutment region to abut against a second reference plane formed vertical to the imaging surface; and
a third abutment region to abut against a third reference plane formed vertical to the imaging surface and to the second reference plane.

3. An imaging device unit according to claim 1,
wherein the abutment region comprises a projection formed on the board.

4. A camera body to removably attach to an imaging device unit having a solid-state imaging device, the camera body comprising:
a body case;
an objective lens mounted on the body case; and
a receptacle formed in the body case and to attach to the imaging device unit,
wherein the receptacle comprises a reference plate that regulates a position of the imaging device unit such that the solid-state imaging device has an imaging surface in a position coincident with a focal point in a state the imaging device unit is attached to the receptacle.

5. A camera body according to claim 4,
wherein, in a state the imaging device unit is attached to the receptacle, the reference plate comprises: a first reference plane vertical to the optical axis of the objective lens; a second reference plane formed vertical to the imaging surface; and a third reference plane formed vertical to the imaging surface and to the second reference plane, and
the imaging surface is regulated in position by the first, second and third reference planes.

6. A camera body according to claim 4, further comprising
an urge mechanism that pushes the imaging device unit onto the reference plate in a state the imaging device unit is attached to the receptacle.

7. A camera body according to claim 4,
wherein, in a state the imaging device unit is attached to the receptacle, the reference plate comprises: a first reference plane vertical to the optical axis of the objective lens; a second reference plane formed vertical to the imaging surface; and a third reference plane formed vertical to the imaging surface and to the second reference plane, and
the imaging surface is regulated in position by the first, second and third reference planes, and
wherein the camera body further comprises an urge mechanism that pushes the imaging device unit onto the reference plate in a state the imaging device unit is attached to the receptacle, and
the urge mechanism is a biasing member that urges the imaging device unit onto at least one of the first, second and third reference planes.

8. A camera body according to claim 4, further comprising
a window exposing the imaging device unit so that the imaging device unit can be visually perceived from an exterior of the camera body in a state the imaging device unit is attached to the camera body.

9. A camera system comprising:
(i) an imaging device unit to be removably attached to a camera body having an objective lens, the imaging device unit comprising:
a board;
a solid-state imaging device fixed on the board; and
an abutment region formed on the board, and to abut against a reference plate provided on the camera body in a state the imaging device unit is attached to the camera body,
wherein, in a state the abutment region is abutted against the reference plate, the solid-state imaging device has an imaging surface in a position coincident with a focal point of the objective lens; and
(ii) the camera body to removably attach to the imaging device unit, the camera body comprising:
a body case;
an objective lens mounted on the body case; and
a receptacle formed in the body case and to attach to the imaging device unit,
wherein the receptacle comprises the reference plate that regulates a position of the imaging device unit such that the solid-state imaging device has the imaging surface in the position coincident with the focal point in a state the imaging device unit is attached to the receptacle.
